(19) United States
(12) Patent Application Publication
(10) Pub. No.: US 2022/0207447 A1
(43) Pub. Date: Jun. 30, 2022

(54) INFORMATION PROVIDING DEVICE, INFORMATION PROVIDING METHOD, AND STORAGE MEDIUM

(71) Applicant: HONDA MOTOR CO., LTD., Tokyo (JP)

(72) Inventor: Kazuya Watanabe, Tokyo (JP)

(21) Appl. No.: 17/557,085

(22) Filed: Dec. 21, 2021

(30) Foreign Application Priority Data
Dec. 28, 2020 (JP) 2020-218911

(51) Int. Cl. G06Q 10/06

(52) U.S. Cl. CPC G06Q 10/06311

(57) ABSTRACT

According to an embodiment, an information providing device includes a provider configured to provide a mobile communication device of a user with information to be output from the mobile communication device in an online state on the basis of information acquired from the mobile communication device, a schedule acquirer configured to acquire a schedule of the user, a schedule predictor configured to predict a schedule of the user, an estimator configured to estimate a situation in which the mobile communication device of the user will be in an offline state in the future on the basis of the schedule acquired by the schedule acquirer and the schedule predicted by the schedule predictor, and a retention information determiner configured to determine information to be retained in the mobile communication device on the basis of an estimation result of the estimator.

### CROSS-REFERENCE TO RELATED APPLICATION

Priority is claimed on Japanese Patent Application No. 2020-218911, filed Dec. 28, 2020, the content of which is incorporated herein by reference.

### BACKGROUND

### Field of the Invention

The present invention relates to an information providing device, an information providing method, and a storage medium.

### Description of Related Art

In the related art, there is technology for transmitting a request received from a user by a mobile communication device to a server, receiving information according to the request from the server, and providing the received information (for example, Japanese Unexamined Patent Application, First Publication No. 2014-63229 and Published Japanese Translation No. 2019-536172 of the PCT International Publication). In Japanese Unexamined Patent Application, First Publication No. 2014-63229, technology for storing the next story information of an electronic book product in a content display device in advance and providing the next story information to the user even in a state in which the content display device is in an offline state when the user finishes reading the electronic book product is disclosed. Published Japanese Translation No. 2019-536172 of the PCT International Publication discloses technology including a user's search history and browsing history as key information when digital content and the like are searched for.

### SUMMARY

When a mobile communication device operates in an offline state in association with an information providing device, information desired to be acquired by a user differs according to a situation of the user and the like. However, when offline data is generated under the assumption of all situations, unnecessary information may be actually retained in the mobile communication device as offline data, and therefore pressure may be put on a memory within the device and necessary information may not be retained. Thus, when the mobile communication device is in the offline state, it may be difficult to provide more appropriate information to the user.

Aspects of the present invention have been made in consideration of such circumstances and an objective of the present invention is to provide an information providing device, an information providing method, and a storage medium capable of providing more appropriate information to a user even if the mobile communication device is in an offline state.

An information providing device, an information providing method, and a storage medium according to the present invention adopt the following configurations.

(1): According to an aspect of the present invention, there is provided an information providing device including: a provider configured to provide a mobile communication device of a user with information to be output from the mobile communication device in an online state on the basis of information acquired from the mobile communication device; a schedule acquirer configured to acquire a schedule of the user; a schedule predictor configured to predict a schedule of the user; an estimator configured to estimate a situation in which the mobile communication device of the user will be in an offline state in the future on the basis of the schedule acquired by the schedule acquirer and the schedule predicted by the schedule predictor; and a retention information determiner configured to determine information to be retained in the mobile communication device on the basis of an estimation result of the estimator.

(2): In the above-described aspect (1), the retention information determiner determines information to be retained in the mobile communication device on the basis of orientation information indicating orientation of the user and utterance information between the user and the mobile communication device.

(3): In the above-described aspect (1), the mobile communication device includes a device mounted in a vehicle.

(4): In the above-described aspect (3), the vehicle is an automated driving vehicle, and the retention information determiner causes one or both of the number of types of information and an amount of information to be retained in the mobile communication device to be greater when the automated driving vehicle is traveling in an automated driving mode than when the automated driving vehicle is not traveling in the automated driving mode.

(5): In the above-described aspect (1), the schedule predictor performs a prediction process related to location information or time information for the user to eat, move, or rest.

(6): In the above-described aspect (1), the information to be output from the mobile communication device is information to be output from the mobile communication device in the offline state, and the information to be output from the mobile communication device includes audio information for interacting with the user.

(7): In the above-described aspect (1), the retention information determiner adjusts information to be provided in accordance with an empty space of a storage provided in the mobile communication device and to be retained in the mobile communication device.

(8): According to another aspect of the present invention, there is provided an information providing method including: providing, by a computer, a mobile communication device of a user with information to be output from the mobile communication device in an online state on the basis of information acquired from the mobile communication device; acquiring, by the computer, a schedule of the user; predicting, by the computer, a schedule of the user; estimating, by the computer, a situation in which the mobile communication device of the user will be in an offline state in the future on the basis of the acquired schedule and the predicted schedule; and determining, by the computer, information to be retained in the mobile communication device on the basis of an estimation result.

(9): According to still another aspect of the present invention, there is provided a computer-readable non-transitory storage medium storing a program for causing a computer to: provide a mobile communication device of a user with information to be output from the mobile communication device in an online state on the basis of information acquired from the mobile communication device; acquire a schedule of the user; predict a schedule of the user; estimate a situation in which the mobile communication device of the user will be in an offline state in the future on the basis of the acquired schedule and the predicted schedule; and determine information to be retained in the mobile communication device on the basis of an estimation result.

According to the above-described aspects (1) to (9), it is possible to provide a user with more appropriate information even if a mobile communication device is in an offline state.

### BRIEF DESCRIPTION OF THE DRAWINGS

FIG. 1 is a configuration diagram of an information providing system including an information providing device of an embodiment.

FIG. 2 is a diagram for describing content of a user information database (DB).

FIG. 3 is a diagram for describing content of schedule information.

FIG. 4 is a diagram for describing content of individual movement history information.

FIG. 5 is a diagram for describing content of group movement history information.

FIG. 6 is a diagram for describing content of point of interest (POI) search history information.

FIG. 7 is a diagram for describing content of group search history information.

FIG. 8 is a diagram for describing content of inquiry information.

FIG. 9 is a diagram for describing content of offline data.

FIG. 10 is a configuration diagram of a communication terminal according to the embodiment.

FIG. 11 is a diagram showing an example of a schematic configuration of a vehicle M equipped with an agent device of the embodiment.

FIG. 12 is a diagram for describing a flow until offline data is generated and provided.

FIG. 13 is a diagram showing an example in which information is provided in an offline state.

FIG. 14 is a diagram for describing information provided to a user in manual driving and automated driving.

FIG. 15 is a flowchart showing an example of a flow of a process executed by the information providing device.

FIG. 16 is a flowchart showing an example of a process executed by the communication terminal.

### DESCRIPTION OF EMBODIMENTS

Hereinafter, embodiments of an information providing device, an information providing method, and a storage medium of the present invention will be described with reference to the drawings.

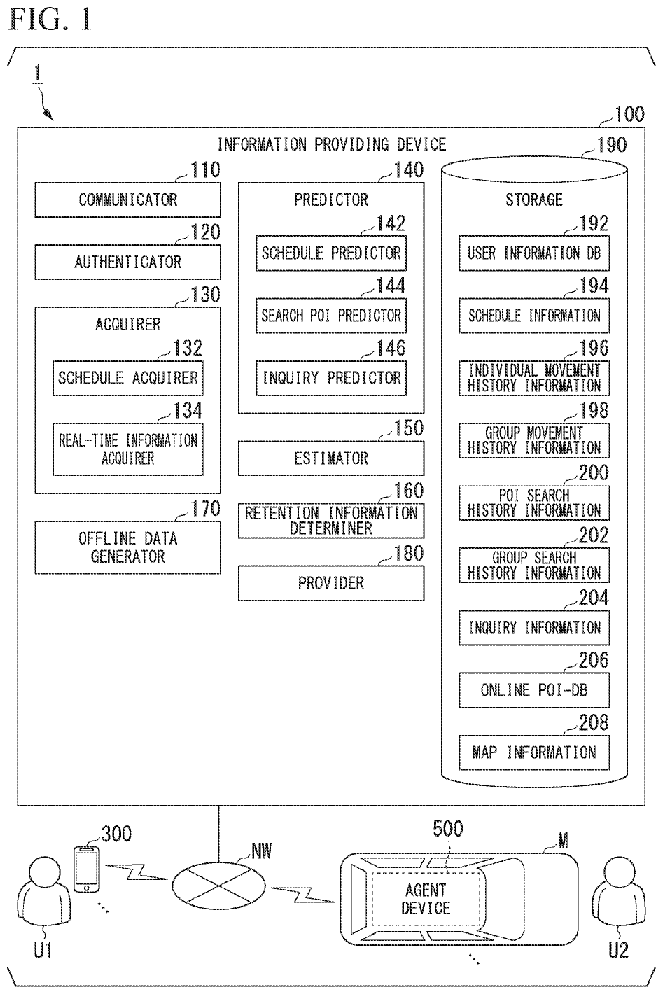

FIG. 1 is a configuration diagram of an information providing system 1 including an information providing device 100 of the embodiment. The information providing system 1 includes, for example, the information providing device 100, a communication terminal 300 used by a user U1 of the information providing system 1, and a vehicle M used by a user U2 of the information providing system 1. These components can communicate with each other via a network NW. The network NW includes, for example, the Internet, a wide area network (WAN), a local area network (LAN), a telephone circuit, a public circuit, a dedicated circuit, a provider device, a radio base station, and the like. The information providing system 1 may include a plurality of communication terminals 300 and/or a plurality of vehicles M. The vehicle M includes, for example, an agent device 500. Each of the communication terminal 300 and the agent device 500 is an example of a “mobile communication device.” Hereinafter, in the information providing system 1, a state in which the information providing device 100 can communicate with the communication terminal 300 or the vehicle M via the network NW in real time is referred to as an “online state” and a state in which the information providing device 100 cannot communicate with the communication terminal 300 or the vehicle M via the network NW in real time is referred to as an “offline state.” The real time may include a prescribed permissible time. For example, it is assumed that the real-time communication is possible when the communication state returns from a state in which communication is disabled to a state in which communication is enabled within a prescribed time period (for example, 5 to 10 [seconds]). The offline state is caused, for example, due to deterioration of a communication environment, a network error, a failure of a communication device (a transceiver), or the like.

The information providing device 100 receives information of an inquiry, a request, or the like of the user U1 from the communication terminal 300 in an online state associated with the communication terminal 300 (hereinafter simply referred to as “inquiry information”), performs a process according to the received inquiry information, and transmits a processing result to the communication terminal 300. The information providing device 100 receives the inquiry information of the user U2 from the agent device 500 mounted in the vehicle M in the online state in association with the agent device 500, performs a process in accordance with the received inquiry information, and transmits a processing result to the agent device 500. The information providing device 100 generates offline data in advance so that information can be provided to the users U1 and U2 even if the communication terminal 300 or the agent device 500 will be in an offline state in the future and transmits the generated offline data to the communication terminal 300 or the agent device 500. The future is, for example, a period from a present time point to a time point which is a prescribed time period later than the present time point. The prescribed time period may be a fixed time period or a variable time period that is changed with the user's situation (for example, a location or a transportation means). The information providing device 100 may function as, for example, a cloud server that communicates with the communication terminal 300 and the agent device 500 via the network NW, and transmits/receives various types of data.

The communication terminal 300 is, for example, a portable terminal such as a smartphone or a tablet terminal. The communication terminal 300 transmits location information of the communication terminal 300, information input by the user U1, and the like to the information providing device 100 via the network NW at a prescribed interval or a prescribed timing. The communication terminal 300 receives inquiry information from the user U1. When the communication terminal 300 is in the online state in association with the information providing device 100, the communication terminal 300 transmits the received inquiry information to the information providing device 100, receives response information for the transmitted information, and causes the response information to be output to the display or the like. When the communication terminal 300 is in the offline state in association with the information providing device 100, the communication terminal 300 generates response information corresponding to the inquiry information with reference to the offline data stored in the storage on the basis of the received inquiry information and causes the response information to be displayed on the display or the like.

The vehicle M in which the agent device 500 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power with which a secondary battery or a fuel cell is discharged. The vehicle M may be an automated driving vehicle. The automated driving is, for example, automatically controlling one or both of the steering or the speed of the vehicle to execute the driving control. The driving control of the vehicle described above may include, for example, various types of driving control such as adaptive cruise control (ACC), auto lane changing (ALC), lane keeping assistance system (LKAS), and traffic jam pilot (TJP). The automated driving vehicle has an automated driving mode in which the above-described driving control is executed and a manual driving mode in which driving is controlled according to the manual driving of an occupant (a driver). In the case of the automated driving mode, the number of tasks assigned to the occupant is smaller than in the manual driving mode. The tasks imposed on the occupant include, for example, monitoring of surroundings of the vehicle M and an operation on a driving operation element (for example, an operation of gripping a steering wheel). Therefore, during the execution of the automated driving mode, for example, the occupant does not need to monitor the surroundings or grip the steering wheel, and therefore can operate the communication terminal 300 while the vehicle M is traveling or view an image and the like displayed on a screen of the communication terminal 300 or the agent device 500.

The agent device 500 transmits the location information of the vehicle M (the agent device 500), the information input by the user U2, the current driving mode (the automated driving mode or the manual driving mode), and the like to the information providing device 100 via the network NW at a prescribed interval or a prescribed timing. The agent device 500 interacts with the occupant of the vehicle M (for example, the user U2) and provides response information for inquiry information received from the occupant. For example, when the agent device 500 is in an online state in association with the information providing device 100, the agent device 500 transmits the received inquiry information to the information providing device 100, receives response information for the transmitted information, and causes the response information to be output to the display device or the like. When the agent device 500 is in an offline state in association with the information providing device 100, the agent device 500 generates response information with reference to the offline data stored in the storage on the basis of the received inquiry information and causes the response information to be output to the display device or the like.

### Information providing device

The information providing device 100 includes, for example, a communicator 110, an authenticator 120, an acquirer 130, a predictor 140, an estimator 150, a retention information determiner 160, an offline data generator 170, a provider 180, and a storage 190. The authenticator 120, the acquirer 130, the predictor 140, the estimator 150, the retention information determiner 160, the offline data generator 170, and the provider 180 are implemented by, for example, a hardware processor such as a central processing unit (CPU) executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as a hard disk drive (HDD) or a flash memory or may be stored in a removable storage medium (a non-transitory storage medium) such as a DVD or a CD-ROM and installed in the storage device of the information providing device 100 when the storage medium is mounted in a drive device or the like.

The storage 190 may be implemented by the above-mentioned various types of storage devices, an electrically erasable programmable read-only memory (EEPROM), a read-only memory (ROM), a random-access memory (RAM), or the like. In the storage 190, for example, a user information database (DB) 192, schedule information 194, individual movement history information 196, group movement history information 198, point of interest (POI) search history information 200, group search history information 202, inquiry information 204, an online POI-DB 206, map information 208, programs, and various other types of information are stored. Among the various types of information and DBs stored in the storage 190, at least some may be stored in a communicable external device.

The user information DB 192 includes, for example, information for identifying a user who uses the information providing device 100, information used for an authentication process of the authenticator 120, and the like. The schedule information 194 is information about a future schedule for each user and is schedule information stored in a scheduler (a schedule management system) of a mobile communication device, a server, or the like.

The individual movement history information 196 is, for example, history information of a user's individual movement. The group movement history information 198 is, for example, history information of a user's movement in a group (a plurality of persons). The POI search history information 200 includes, for example, history information of a user searching for POI information using the mobile communication device (for example, the communication terminal 300, the agent device 500, or the like). The POI information includes information about shops and facilities, structures such as bridges and steel towers, and geographic features such as topographical features (mountains, rivers, seas, ponds, and lakes) present in correspondence with location information. The POI information includes, for example, text information, image (still image or moving image) information, audio information, and the like.

The inquiry information 204 is, for example, information obtained by extracting a part of an element that becomes meta-data included in information about which the user asks the mobile communication device. Elements that become meta-data include, for example, a genre (a meal, sports, news, clothing, or parking lots), a data source (for example, an image, a video, speech, a review (evaluation), or a tag), an amount of information (an amount of data), and the like. The online POI-DB 206 is information of various types of DBs that provide response information for inquiry information from a mobile communication device in an online state.

The map information 208 is, for example, information in which a road shape is expressed by a link indicating a road and nodes connected by the link. The map information 208 may include guidance information associated with road curvature, lane information, and location information. The guidance information is, for example, POI information. The map information 208 includes information about a center of a lane, information about a boundary of a lane, and the like. The map information 208 may include road information, traffic regulation information, address information (an address/postal code), facility information, telephone number information, and the like. The map information 208 stores, for example, the latest map data of a wide range.

The communicator 110 communicates with the communication terminal 300, the agent device 500, and other external devices via the network NW.

The authenticator 120 registers information (a user information DB 192) about users (the users U1 and U2 and the like) who use the information providing system 1. For example, when a user registration request has been received from a mobile communication device (the communication terminal 300 or the agent device 500), the authenticator 120 generates an image for inputting various types of information which is included in the user information DB 192, causes the generated image to be displayed on the mobile communication device that has received the registration request, and acquires information about the user input from the mobile communication device. The authenticator 120 registers the information about the user acquired from the mobile communication device in the user information DB 192 of the storage 190.

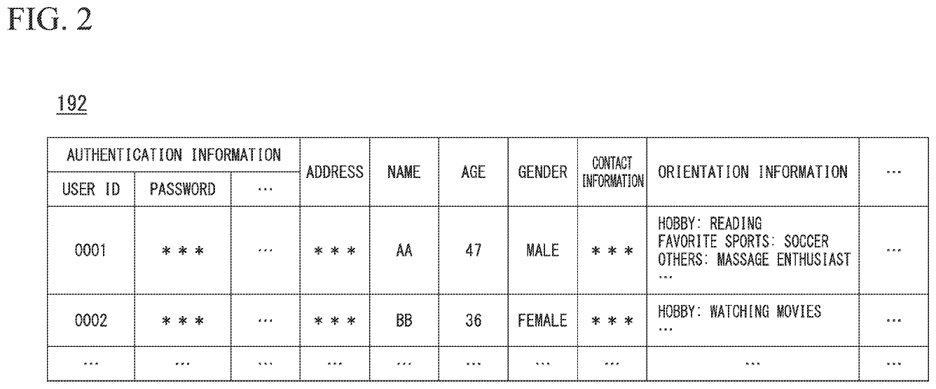

FIG. 2 is a diagram for describing content of the user information DB 192. In the user information DB 192, for example, information such as an address, a name, an age, a gender, contact information, and orientation information are associated with authentication information for authenticating a user when the information providing system 1 is used and the like. The authentication information includes, for example, a user ID, a password, and the like, which are identification information for identifying the user. The authentication information may include biometric information such as fingerprint information and iris information. The contact information may be, for example, address information for communicating with the mobile communication device (the communication terminal 300 or the agent device 500) used by the user, and may be a telephone number, an e-mail address, terminal identification information, or the like of the user. The orientation information is, for example, information indicating the orientation of the user, for example, information indicating the user's way of thinking, information indicating hobbies, preferences, and the like (preference information), habits of the user, and information indicating what the user values. The user information DB 192 may include information about a family structure and a workplace of the user and the like. The information providing device 100 communicates with the user's mobile communication device on the basis of the contact information and provides various types of information.

The authenticator 120 authenticates a user who uses a service of the information providing system 1 on the basis of the user information DB 192 registered in advance. For example, the authenticator 120 authenticates the user at the timing when a request for use of a service (an information providing service) according to the embodiment from the mobile communication device has been received. For example, when the request for use has been received, the authenticator 120 generates an authentication image for inputting authentication information such as a user ID and a password, causes the generated image to be displayed on the mobile communication device that has transmitted the request, and determines whether or not to permit the use of the service according to whether or not the authentication information matching the input authentication information has been stored with reference to the authentication information of the user information DB 192 on the basis of input authentication information input using the displayed image. For example, the authenticator 120 permits the use of the service when the authentication information matching the input authentication information is included in the user information DB 192 and performs a process of blocking the use of the service or performing new registration when the matching information is not included.

The acquirer 130 acquires information input by an administrator of the information providing device 100 and various types of information from the mobile communication device and other external devices connected to the network NW. The acquirer 130 includes, for example, a schedule acquirer 132 and a real-time information acquirer 134. The schedule acquirer 132 acquires schedule information of the user from a mobile communication device or an external device (for example, a schedule management server) or the like via the network NW. The schedule acquirer 132 stores the acquired information as the schedule information 194 in the storage 190.

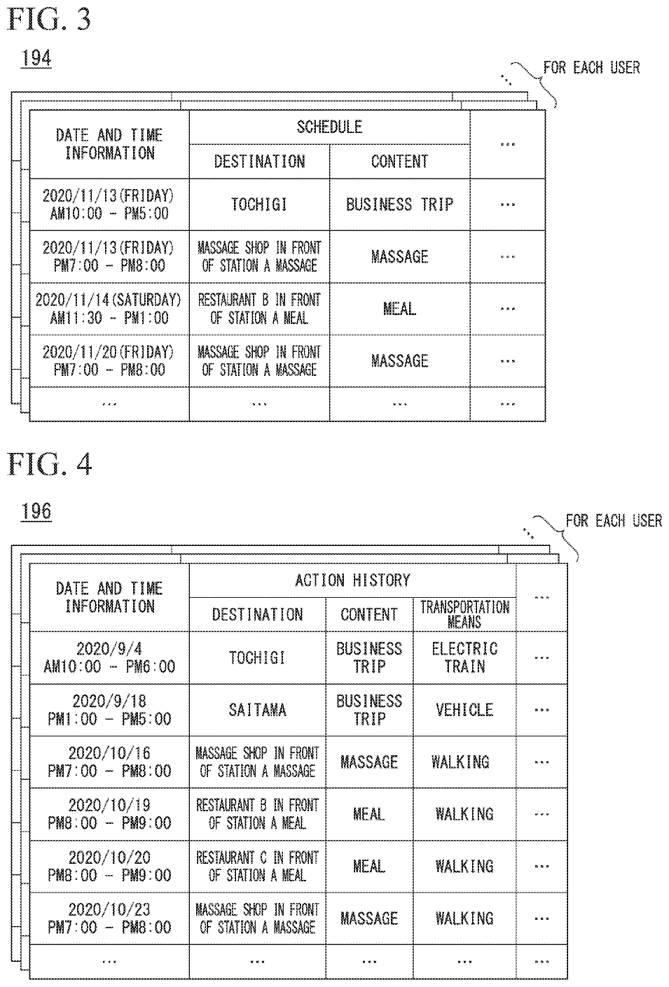

FIG. 3 is a diagram for describing content of the schedule information 194. The schedule information 194 is, for example, information in which a schedule is associated with date and time information. The date and time information is, for example, information about a period from a start date (a start time point) to an end date (an end time point). The date and time information may be only information about a date or only information about a time point. The schedule shown in FIG. 3 includes, for example, a destination (a destination place or a movement destination) and content. The destination may be, for example, information for identifying a place such as an address, information for identifying a general region of a destination such as a shop name, a facility name, or a station name The schedule information 194 is stored for each user.

The real-time information acquirer 134 acquires real-time information from the mobile communication device via the network NW. The real-time information may include, for example, time (date and time) information, location information of the mobile communication device, utterance information of the user, search information, and the like. The real-time information may include a state of a companion (a passenger of the vehicle M in the case of the agent device 500) acting together with the user, a state of the user (the occupant of the vehicle M in the case of the agent device 500), information about a time period after the movement of the user starts (a driving time period of the vehicle M of the occupant in the case of the agent device 500), and information about a transportation means and the like. When the real-time information is acquired from the agent device 500, the real-time information may include information about the driving mode of the vehicle M and information about the state of the vehicle M (a traveling location, a traveling direction, a speed, or the like). The acquirer 130 causes the storage 190 to store the individual movement history information 196, the group movement history information 198, the POI search history information 200, and the like on the basis of the information acquired by the schedule acquirer 132 and the real-time information acquirer 134.

FIG. 4 is a diagram for describing content of the individual movement history information 196. The individual movement history information 196 is, for example, information in which an action history is associated with date and time information. The action history includes, for example, a destination, content, and a transportation means (for example, an electric train, a vehicle, or walking). The content shown in FIG. 4 includes content related to the purpose of movement. The individual movement history information 196 may include information (moving range information) about a range in which an individual is active on a daily basis (for example, the nearest station for commuting to work or school). The individual movement history information 196 may include information about a trend in how the user moves (an individual movement trend) when the user moves individually. The individual movement history information 196 is stored for each user.

For example, the acquirer 130 generates the individual movement history information 196 on the basis of real-time information and causes the storage 190 to store the individual movement history information 196. The acquirer 130 may collate the information included in the schedule information 194 with the real-time information and store information of a destination and content included in the schedule information 194 as information of a destination and content of the individual movement history information 196 when the user is moving as scheduled (for example, when the location of the mobile communication device included in the real-time information is within a prescribed distance from the destination of the schedule information 194). The acquirer 130 may generate an image for inputting the individual movement history at a prescribed interval or a prescribed timing, cause the generated image to be displayed on the mobile communication device, and store an individual movement history input using the displayed image in the individual movement history information 196. The prescribed interval is, for example, every day, every week, or every prescribed number of days. The prescribed timing is, for example, a timing at which the date or week changes, or another timing that is set arbitrarily.

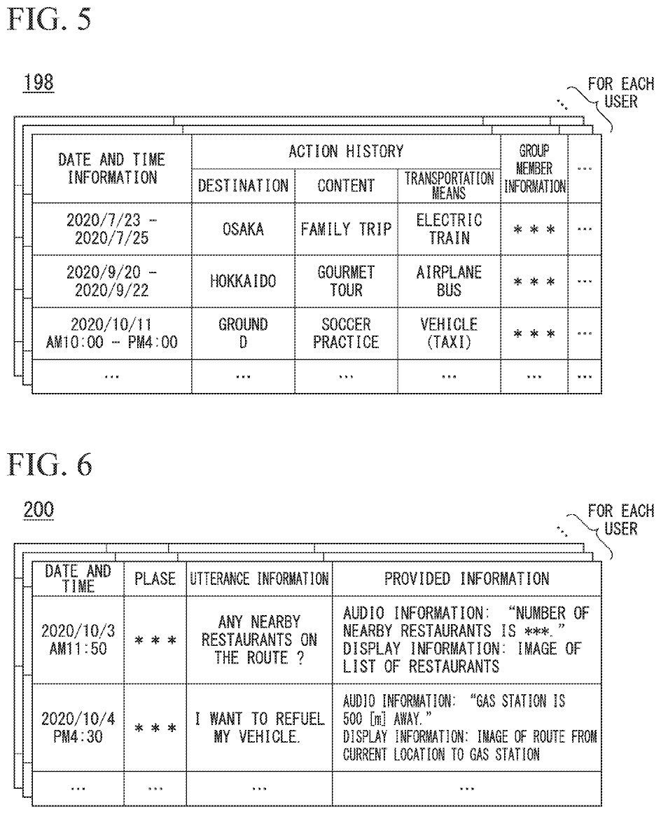

The group movement history information 198 is information that is managed so that movement histories of a plurality of users can be used cross-sectionally. The group movement history information 198 may be history information in which the user has moved in a group. FIG. 5 is a diagram for describing content of the group movement history information 198. The group movement history information 198 is, for example, information in which an action history and group member information are associated with date and time information. The action history includes, for example, a destination, action content, and a transportation means. The group member information is, for example, feature information of other members (for example, a companion and a passenger) when the user participates in a gourmet tour, a bus tour, or the like. Members may include a small number of others such as family and friends. The feature information includes, for example, individual information (for example, an age, a gender, and an address). The feature information may include feature information of all group members such as a ratio of men to women and a percentage of each age group. The group movement history information 198 may include information about a trend in how the user moves (a group movement trend) when the user moves in a group. The group movement history information 198 is stored for each user. The group movement history information 198 may be information grouped according to conditions other than the movement of a group (for example, specific to a gender, an age group, a destination, or a transportation means) regardless of whether or not a plurality of persons are moving in a group.

For example, when there is companion (or passenger) information in the real-time information, the acquirer 130 generates the group movement history information 198 on the basis of the real-time information and causes the storage 190 to store the group movement history information 198. When the location information of the mobile communication device included in the real-time information and a trend of a change in the location are common or similar among the plurality of users, the acquirer 130 assumes that the plurality of users are moving in a group and stores the movement history information in the group movement history information 198. The acquirer 130 may generate an image for inputting the group movement history at a prescribed interval or a prescribed timing, cause the generated image to be displayed on the mobile communication device, and store the group movement history input using the displayed image in the group movement history information 198.

The predictor 140 performs a prediction process related to the user or the like on the basis of various types of information and DBs stored in the storage 190. The predictor 140 includes, for example, a schedule predictor 142, a search POI predictor 144, and an inquiry predictor 146. For example, the schedule predictor 142 may predict information about a location or time where or when the user will eat, information about a location (a section) or time where or when the user will move, information about a location or time where or when the user will rest, or the like on the basis of the schedule information 194. For example, when the content of the schedule is a “meal,” the schedule predictor 142 acquires destination and date and time information associated with the content of the schedule as prediction information about a location or time where or when the user will eat. When the content of the schedule included in the schedule information 194 is a “business trip,” the schedule predictor 142 assumes that the user will move and acquires destination and date and time information associated with the content of the schedule as prediction information about the location or time where or when the user will move. When the content of the schedule is “massage,” the schedule predictor 142 assumes that the user will rest and acquires destination and date and time information associated with the content of the schedule as prediction information about the location or time where or when the user will rest. What content corresponds to movement, a meal, rest, or the like is preset.

The schedule predictor 142 may predict a destination or a route on the basis of the schedule information 194, the individual movement history information 196, and the group movement history information 198. When the mobile communication device is the agent device 500, the schedule predictor 142 may acquire information of the destination set by the navigation device mounted in the vehicle M and predict a route to the destination with reference to the map information 208 from the acquired destination and the current location of the vehicle M. The schedule predictor 142 may predict a moving range of the user, a situation of occurrence of an offline state, and the like in the future on the basis of the schedule information 194, the individual movement history information 196, and the group movement history information 198. For example, the schedule predictor 142 predicts a location or a region of the destination where the transportation means is walking as the moving range of the user on the basis of a past action history in the individual movement history information 196. For example, the schedule predictor 142 may analyze an interval or the like when the user moves to the same destination on the basis of the past action history in the individual movement history information 196 and predict a date and time when the user will go to the same destination in the future. The schedule predictor 142 may predict a timing or a destination when or where the user will move in a group and the like in the future from the group movement history information 198. The schedule predictor 142 collates the predicted destination with destinations of action histories of the individual movement history information 196 and the group movement history information 198 and predicts a date and time and the like when the offline state will occur in the future from the transportation means of the action history associated with the matching destination. The match may include a prescribed error range. For example, the schedule predictor 142 predicts that an offline state will occur when the transportation means of the action history associated with the matching destination is an electric train or an airplane. The schedule predictor 142 predicts that an offline state will occur while a vehicle passes through a tunnel or the like from a location or a traveling direction of the vehicle when the transportation means of the action history associated with the matching destination is the vehicle. The schedule predictor 142 may store, for example, information about the predicted schedule in the schedule information 194.

For example, the search POI predictor 144 predicts POI information that is likely to be searched for in the future on the basis of POI information that the user of the POI search history information 200, the group search history information 202, and the like searched for (about which the user asked) in the past. FIG. 6 is a diagram for describing content of the POI search history information 200. The POI search history information 200 is, for example, information in which a place, utterance information, and provided information are associated with date and time information. The place is, for example, location information of the mobile communication device when the utterance information is acquired from the user. The utterance information is, for example, information included in the real-time information acquired by the real-time information acquirer 134. The provided information is, for example, information provided by the provider 180. The provided information includes, for example, audio information for an interaction, images or display information of operations and the like, information of a route to the location of the shop or facility to be provided, and the like. The POI search history information 200 is stored, for example, for each user.

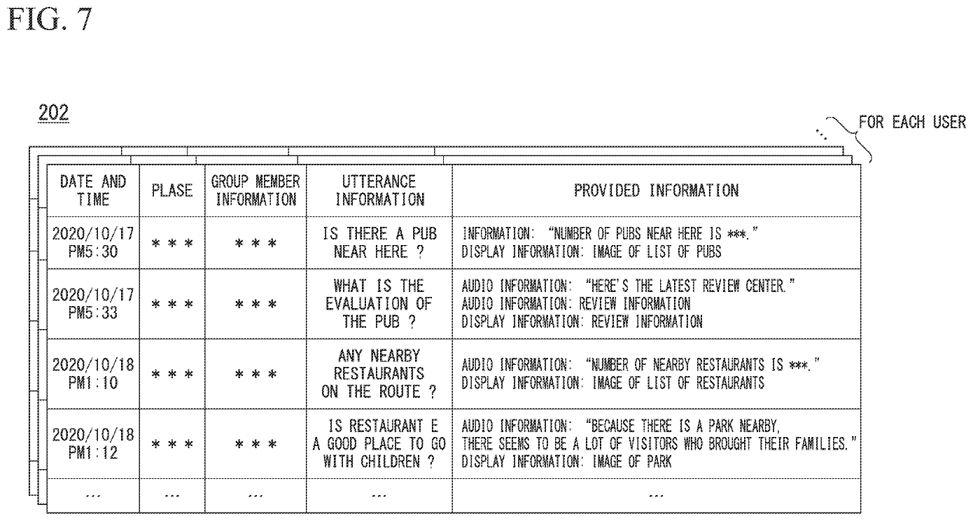

The group search history information 202 is, for example, user search data that can be used across search histories of a plurality of users (for example, users A to X). The group search history information 202 may be a search history when the user acts in a group. FIG. 7 is a diagram for describing content of the group search history information 202. The group search history information is, for example, information in which a place, group member information, utterance information, and provided information are associated with date and time information. The group search history information 202 is stored, for example, for each user. When search histories of a plurality of users are used cross-sectionally regardless of whether or not group movement has been made in the group search history information 202, the group member information may not be included in the group search history information 202. The group search history information 202 shown in FIG. 7 may be used for a cross-sectional search including a search history of another user in accordance with conditions of a date and time, a place, utterance information, and the like. The POI search history information 200 and the group search history information 202 are registered or updated by the provider 180. For example, the search POI predictor 144 collates the location information of the mobile communication device included in the real-time information with places stored in the POI search history information 200 and the group search history information 202 and predicts utterance information corresponding to a matching place as search POI information to be used by the user in the future. The search POI predictor 144 may collate a destination predicted by the schedule predictor 142 with the places stored in the POI search history information 200 and the group search history information 202 and predict utterance information corresponding to the matching place as the search POI information to be used by the user in the future. The search POI predictor 144 may predict the provided information as the search POI information in addition to the utterance information.

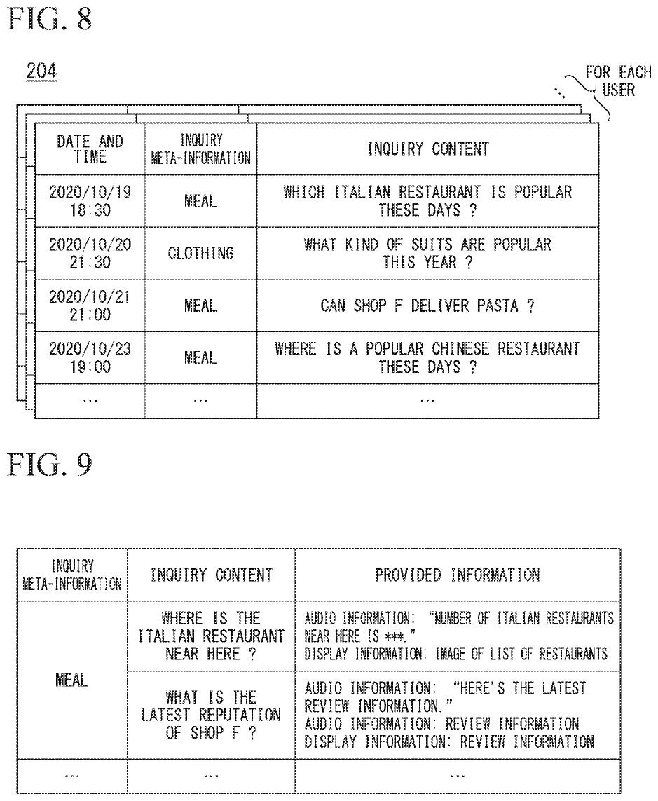

The inquiry predictor 146 predicts information about which users frequently ask on the basis of the POI search history information 200 and the group search history information 202 on the basis of the inquiry information 204. The inquiry predictor 146 predicts information about which the user will be likely to ask in the future. FIG. 8 is a diagram for describing content of the inquiry information 204. The inquiry information 204 is information in which inquiry meta-information and inquiry content are associated with date and time information. The inquiry meta-information is, for example, information about an element that becomes meta-data included in the utterance information accumulated in the POI search history information 200 and the group search history information 202. The inquiry information is utterance information. The inquiry information 204 is registered or updated by, for example, the provider 180. The inquiry information 204 is stored, for example, for each user. The inquiry predictor 146 predicts meta-information about which the user is predicted to ask in the future for each prescribed time period with reference to the date and time information. The meta-information may include inquiry information.

The estimator 150 estimates a future situation of the user, a situation (for example, a time point (period) or a place when or where) in which the mobile communication device of the user will be in an offline state in association with the information providing device 100 in the future, and the like on the basis of the schedule acquired by the schedule acquirer 132 and the schedule predicted by the schedule predictor 142. The estimator 150 may also include the real-time information acquired by the real-time information acquirer 134 to estimate a situation in which the state will be the offline state. The estimator 150 may estimate whether or not the mobile communication device will be in an offline state within a prescribed time period. The prescribed time period may be a fixed time period or a variable time period that is changed with the user's situation (for example, a location or a transportation means).

The retention information determiner 160 determines information (offline data) to be retained in the mobile communication device on the basis of an estimation result of the estimator 150. For example, the retention information determiner 160 determines information to be included in the offline data on the basis of the estimation result, the user's orientation information stored in the user information DB 192, and the user's utterance information for the mobile communication device included in the real-time information. The offline data includes, for example, POI information, map information, and the like. For example, when the estimator 150 estimates whether or not the state will be an offline state in the future, the retention information determiner 160 determines to include information about which the user is estimated to ask in the offline state (inquiry information) and response information for the inquiry information in the offline data on the basis of a location or a time period where or when the state will be the offline state, orientation information of the user, utterance information, and the like. When the estimator 150 estimates that the mobile communication device will not be in the offline state within a prescribed time period, the retention information determiner 160 determines to include information about which the user is estimated to ask (inquiry information) and response information for the inquiry information in the offline data on the basis of a location of the mobile communication device, real-time information, orientation information of the user, utterance information, and the like during a period from a present time point to a prescribed time point.

When the vehicle (the automated driving vehicle) M equipped with the agent device 500 is traveling in the automated driving mode, the retention information determiner 160 may determine information to be included in the offline data to be retained so that one or both of the number of types of offline data to be retained in the mobile communication device and an amount of information thereof are greater than when the automated driving vehicle is not traveling in the automated driving mode. For example, the retention information determiner 160 is configured so that the offline data does not include content of a video or the like (a data source) or text information in which the number of characters (an example of an amount of information) is large because a task such as monitoring of surroundings of the vehicle M is imposed on the user (the driver) when the vehicle M is traveling in the manual driving mode and the offline data includes a video or text information in which the number of characters is large when the vehicle M is traveling in the automated driving mode and a task of monitoring the surroundings of the vehicle M is not imposed on the user. The retention information determiner 160 may estimate the remaining time period for the automated driving mode to continue on the basis of the location information of the vehicle M, and the like and adjust a type of information to be included in the offline data and an amount of information in accordance with the estimated remaining time period. In this case, for example, an adjustment is made so that the number of types of information to be included in the offline data or an amount of information increases as the duration of the automated driving mode increases.

The retention information determiner 160 may acquire a space (for example, an empty space) of the storage (a terminal-side storage or a vehicle-side storage) of the mobile communication device and adjust a type of offline data or an amount of information thereof on the basis of the acquired space. Thereby, it is possible to limit a situation in which offline data cannot be stored due to an insufficient empty space.

The offline data generator 170 generates offline data storing information included in the offline data determined by the retention information determiner 160 at a prescribed interval or a prescribed timing. The prescribed timing is, for example, a timing when the mobile communication device of the user will be in the offline state in the future estimated by the estimator 150, a timing when the mobile communication device requests offline data, or the like. FIG. 9 is a diagram for describing content of the offline data. The offline data is data in which the provided information is associated with the inquiry meta-information and the inquiry content. The display information may be text information or may be information of a still image or a moving image. The display information may include map information and route information.

The offline data generator 170 acquires the inquiry information corresponding to the information to be included in the offline data determined by the retention information determiner 160 and the provided information (the response information) corresponding to the inquiry information from the online POI-DB 206. Here, the provided information included in the offline information may include individual POI information for each user. The individual POI information is POI information in which the user is predicted to be interested on the basis of, for example, the individual movement history information 196, the group movement history information 198, the POI search history information 200, the group search history information 202, and the like. The offline data generator 170 counts the same information within the information extracted from the above-mentioned history information, and acquires a prescribed number of pieces of information as individual POI information in descending order of count value. The offline data generator 170 may acquire individual POI information by inputting the above-mentioned history information to a learning model in which the history information is input data and the POI information indicating the user's interest is output data. The learning model is a preset model and may be updated according to feedback control using correct answer data or the like. According to individual POI information, for example, when information of a certain shop is provided, information about a cooking menu can be provided if the user is interested in the menu and information about reputation (a review) of the shop can be provided if the user is interested in reputation or popularity.

The provider 180 provides various types of information to the mobile communication device (the communication terminal 300 or the agent device 500). For example, the provider 180 generates the response information (the provided information) corresponding to the inquiry information with reference to the online POI-DB 206 for the inquiry information from the mobile communication device and transmits the response information (the provided information) to the mobile communication device. The response information includes at least audio information for interacting with the user. The provider 180 includes a speech recognition function of recognizing speech data (a function of converting speech into text) and a natural language processing function (a function of understanding a structure and meaning of text), and extracts inquiry information from speech data when the speech data has been acquired from the mobile communication device. The provider 180 may have an interaction function for generating speech data or text data for interacting with the user including the response information. Some or all of these functions may be implemented by artificial intelligence (AI) technology. The provider 180 transmits the offline data generated by the offline data generator 170 to the mobile communication device.

The provider 180 may make content of the information to be provided and a timing at which the information is provided different according to whether the mobile communication device that has transmitted the inquiry information is the communication terminal 300 or the agent device 500. For example, when information is provided to the communication terminal 300, the provider 180 provides the information step by step for each piece of data of a prescribed amount or less. Thereby, a communication terminal having low processing capability can also acquire the provided information. The provider 180 may be configured to provide information when the moving speed of the vehicle M is less than a prescribed speed. Thereby, for example, it is possible to limit the neglect of monitoring of surroundings of the vehicle M when the vehicle M travels according to manual driving.

### Communication Terminal

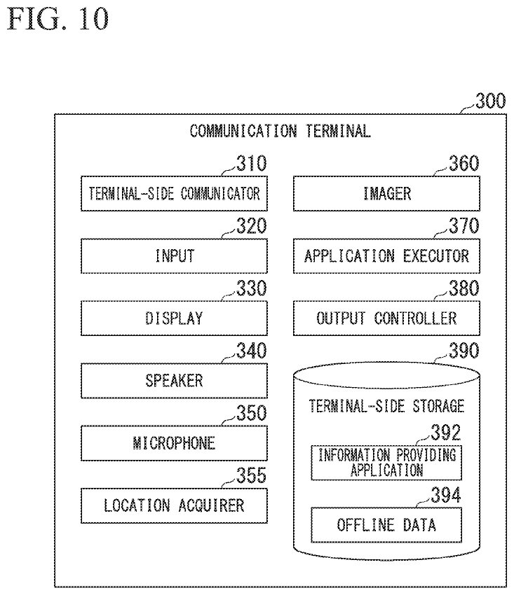

Next, a configuration of the communication terminal 300 will be described. FIG. 10 is a configuration diagram of the communication terminal 300 of the embodiment. The communication terminal 300 includes, for example, a terminal-side communicator 310, an input 320, a display 330, a speaker 340, a microphone 350, a location acquirer 355, an imager 360, an application executor 370, an output controller 380, and a terminal-side storage 390. The location acquirer 355, the application executor 370, and the output controller 380 are implemented by, for example, a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (the non-transitory storage medium) such as a DVD or a CD-ROM and installed in the storage device of the communication terminal 300 when the storage medium is mounted in a drive device, a card slot, or the like.

The terminal-side storage 390 may be implemented by the above-mentioned various types of storage devices, EEPROM, ROM, RAM, or the like. For example, the information providing application 392, the offline data 394, the program, and various other types of information are stored in the terminal-side storage 390. The offline data 394 is provided from the information providing device 100.

The terminal-side communicator 310 communicates with the information providing device 100, the agent device 500, and other external devices by using, for example, the network NW. The terminal-side communicator 310 periodically performs communication with the information providing device 100 and the like and acquires information of whether the information providing device 100 is in an online or offline state from a communication result, error information, or the like. An acquisition result is output to the application executor 370.

The input 320 receives the input of the user U1 by operating, for example, various types of keys or buttons or the like. The display 330 is, for example, a liquid crystal display (LCD), an organic electro-luminescence (EL) display, or the like. The input 320 may be configured to be integrated with the display 330 as a touch panel. The display 330 displays various types of information in the embodiment according to the control of the output controller 380. For example, the speaker 340 outputs a prescribed speech according to the control of the output controller 380. For example, the microphone 350 receives an input of speech of the user U1 according to the control of the output controller 380.

The location acquirer 355 acquires location information of the communication terminal 300 using a built-in Global Positioning System (GPS) device (not shown). The location information may be, for example, two-dimensional map coordinates or latitude/longitude information.

The imager 360 is, for example, a digital camera using a solid-state imaging element (an image sensor) such as a charge-coupled device (CCD) or a complementary metal-oxide semiconductor (CMOS). The imager 360 captures an image of the user U1 or a companion who accompanies the user U1 according to, for example, an operation of the user U1.

The application executor 370 is implemented by executing the information providing application 392 stored in the terminal-side storage 390. The information providing application 392 is an application program for controlling the output controller 380 so that inquiry information acquired from the display 330 or speech data acquired from the microphone 350 is transmitted to the information providing device 100 and response information provided from the information providing device 100 is output by the display 330 or output from the speaker 340. The response information includes, for example, an image showing a shop or a facility showing a response result for inquiry information or the like, an image or a sound related to each store or facility, an image or a sound showing a traveling route to a destination, other recommendation information, information indicating the start or end of processing, and the like.

For example, an information providing application 392 downloaded from an external device via the network NW is installed in the communication terminal 300. The application executor 370 causes an authentication screen or the like to be displayed on the display 330 at the time of authentication or causes information input by the input 320 to be transmitted to the information providing device 100 via the terminal-side communicator 310. The information providing application 392 outputs location information acquired by the location acquirer 355, an image captured by the imager 360, various types of information processed by the information providing application 392, and the like to the information providing device 100 via the network NW.

The information providing application 392 acquires the offline data 394 from the information providing device 100 at a prescribed interval or a prescribed timing and causes the acquired offline data 394 to be stored in the terminal-side storage 390. When the communication terminal 300 and the information providing device 100 are in the offline state or when the user U1 has received an instruction to use the offline data 394, the information providing application 392 generates a response corresponding to an inquiry or a request with reference to the offline data 394 with respect to inquiry information from the user U1 and the like and outputs the generated response from the display 330, the speaker 340, or the like. By using the offline data 394 according to the instruction of the user U1 not only in the offline state but also in the online state, an amount of communication data can be reduced. The information providing application 392 may be implemented using, for example, a natural language processing function, an interaction management function of interacting with the user U1, a search for another device via a network, or a network search function of searching a prescribed database owned by its own device, and the like in an integrated manner in addition to a speech recognition function of recognizing speech of the user. Some or all of these functions may be implemented by AI technology. Some of the components for performing these functions may be mounted in the information providing device 100.

The output controller 380 controls content and a display mode of an image to be displayed by the display 330 and content and an output mode of a sound to be output by the speaker 340 according to the control of the application executor 370.

### Vehicle

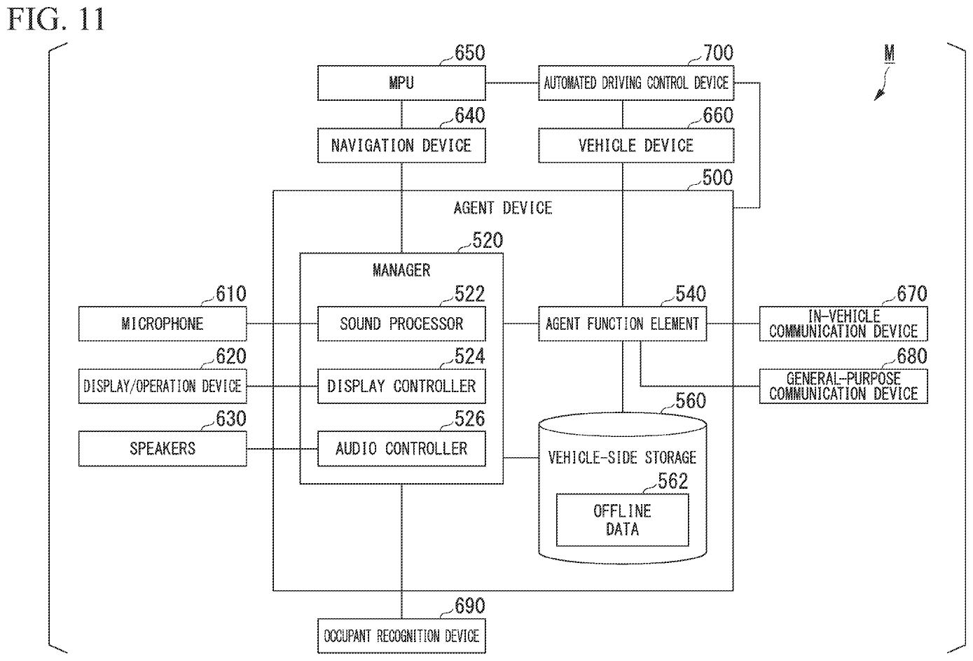

Next, a schematic configuration of the vehicle M in which the agent device 500 is mounted will be described. FIG. 11 is a diagram showing an example of a schematic configuration of the vehicle M in which the agent device 500 of the embodiment is mounted. The vehicle M shown in FIG. 11 includes the agent device 500, a microphone 610, a display/operation device 620, speakers 630, a navigation device 640, a map positioning unit (MPU) 650, a vehicle device 660, an in-vehicle communication device 670, an occupant recognition device 690, and an automated driving control device 700. A general-purpose communication device 680 such as a smartphone may be brought into a cabin and used as a communication device. The general-purpose communication device 680 is, for example, the communication terminal 300. These devices are connected to each other through a multiplex communication line such as a controller area network (CAN) communication line, a serial communication line, a wireless communication network, or the like.

First, a configuration other than the agent device 500 will be described. The microphone 610 is a sound collector that collects speech uttered within the cabin. The display/operation device 620 is a device (or a device group) capable of displaying an image and receiving an input operation. The display/operation device 620 includes, for example, a display device configured as a touch panel. The display/operation device 620 may further include a head-up display (HUD) or a mechanical input device. The speaker 630 outputs, for example, speech, an alarm sound, or the like inside or outside of the vehicle. The display/operation device 620 may be shared by the agent device 500 and the navigation device 640.

The navigation device 640 includes a navigation human-machine interface (HMI), a positioning device such as a GPS, a storage device that stores map information, and a control device (a navigation controller) that performs a route search and the like. Some or all of the microphone 610, the display/operation device 620, and the speaker 630 may be used as the navigation HMI. The navigation device 640 searches for a route (a navigation route) for moving from the location of the vehicle M to a destination input by the user from the map information with reference to the map information on the basis of the location of the vehicle M identified by the positioning device and outputs guidance information using the navigation HMI so that the vehicle M can travel along the route. The route search function may be provided in the information providing device 100 or the navigation server that can be accessed via the network NW. In this case, the navigation device 640 acquires a route from the information providing device 100 or the navigation server and outputs guidance information. The agent device 500 may be constructed on the basis of the navigation controller. In this case, the navigation controller and the agent device 500 are configured to be integrated on the hardware.

For example, the MPU 650 divides a route on the map provided from the navigation device 640 into a plurality of blocks (for example, divides the route every 100 [m] in a traveling direction of the vehicle) and determines a recommended lane for each block. For example, the MPU 650 determines what number lane the vehicle travels in from the left. The MPU 650 may determine the recommended lane using map information (a higher-precision map) that is more precise than the map information stored in the storage device of the navigation device 640. The higher-precision map may be stored in, for example, the storage device of the MPU 650, or may be stored in the storage device of the navigation device 640 or the vehicle-side storage 560 of the agent device 500. The higher-precision map may include information about the center of the lane or information about the boundary of the lane, traffic regulation information, address information (address/postal code), facility information, telephone number information, and the like.

The vehicle device 660 is, for example, a camera (an imager), a radar device, a light detection and ranging (LIDAR) sensor, or a physical object recognition device. The camera is, for example, a digital camera using a solid-state imaging element such as a CCD or a CMOS. The camera is attached to any location on the vehicle M. The radar device radiates radio waves such as millimeter waves around the vehicle M and detects radio waves (reflected waves) reflected by a physical object to detect at least a location (a distance and a direction) of the physical object. The LIDAR sensor radiates light around the vehicle M and measures scattered light. The LIDAR sensor detects a distance to a target on the basis of a time period from light emission to light reception. The physical object recognition device performs sensor fusion processing on detection results of some or all of the camera, the radar device, and the LIDAR sensor, and recognizes a location, a type, a speed, and the like of a physical object near the vehicle M. The physical object recognition device outputs a recognition result to the agent device 500 and the automated driving control device 700.

The vehicle device 660 includes, for example, driving operation elements, a travel driving force output device, a brake device, a steering device, and the like. The driving operation elements include, for example, an accelerator pedal, a brake pedal, shift levers, a steering wheel, a variant steering wheel, a joystick, and other operation elements. A sensor for detecting the amount of operation or the presence or absence of operation is attached to the driving operation element and a detection result is output to the agent device 500, the automated driving control device 700, or some or all of the travel driving force output device, the brake device, and the steering device. The travel driving force output device outputs a travel driving force (torque) for the vehicle M to travel to the drive wheels. The brake device includes, for example, a brake caliper, a cylinder that transfers hydraulic pressure to the brake caliper, an electric motor that generates hydraulic pressure in the cylinder, and a brake ECU. The brake ECU controls the electric motor in accordance with information input from the automated driving control device 700 or information input from the driving operation element so that the brake torque according to the braking operation is output to each wheel. The steering device includes, for example, a steering ECU and an electric motor. For example, the electric motor changes a direction of steerable wheels by applying a force to a rack and pinion mechanism. The steering ECU drives the electric motor in accordance with the information input from the automated driving control device 700 or the information input from the driving operation element to change the direction of the steerable wheels.

The in-vehicle communication device 670 is, for example, a wireless communication device that can access the network NW using a cellular network or a Wi-Fi network. The in-vehicle communication device 670 periodically communicates with the information providing device 100 and acquires information of whether the information providing device 100 is in an online or offline state from a communication result, error information, or the like. An acquisition result is output to the agent device 500.

The occupant recognition device 690 includes, for example, a sitting sensor, a cabin camera, an image recognition device, and the like. The sitting sensor includes a pressure sensor provided on a lower part of a seat, a tension sensor attached to a seat belt, and the like. The cabin camera is a CCD camera or a CMOS camera installed in the cabin. The image recognition device analyzes an image of the cabin camera, recognizes the presence/absence of a user for each seat, a face of the user, and the like, and recognizes a sitting location of the user. The occupant recognition device 690 may identify a driver sitting in the driver's seat or a passenger sitting in a passenger seat or the like included in the image by performing a matching process associated with a face image registered in advance.

The automated driving control device 700 causes the vehicle M to travel in the automated driving mode. The automated driving control device 700 performs a process, for example, when a hardware processor such as a CPU executes a program (software). Some or all of the components of the automated driving control device 700 may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory of the automated driving control device 700 or may be stored in a removable storage medium such as a DVD or a CD-ROM and installed in the HDD or the flash memory of the automated driving control device 700 when the storage medium (the non-transitory storage medium) is mounted in a drive device.

The automated driving control device 700 recognizes states of a location, a speed, acceleration, and the like of a physical object near the vehicle M on the basis of the information input via the physical object recognition device of the vehicle device 660. The automated driving control device 700 generates a future target trajectory along which the vehicle M automatically travels (independently of the driver's operation) so that the vehicle M can generally travel in the recommended lane determined by the MPU 650 and cope with a surrounding situation of the vehicle M. For example, the target trajectory includes a speed element. For example, the target trajectory is represented by sequentially arranging points (trajectory points) at which the vehicle M is required to arrive.

The automated driving control device 700 may set an automated driving event when a target trajectory is generated. Automated driving events include a constant-speed driving event, a low-speed tracking driving event, a lane change event, a branch-point-related event, a merge-point-related event, a takeover event, an automated parking event, and the like. The automated driving control device 700 generates a target trajectory according to an activated event. The automated driving control device 700 controls the travel driving force output device, the brake device, and the steering device of the vehicle device 660 so that the vehicle M passes the generated target trajectory on time. For example, the automated driving control device 700 controls the travel driving force output device or the brake device on the basis of a speed element associated with a target trajectory (a trajectory point) or controls the steering device in accordance with a degree of curvature of the target trajectory.

Next, the agent device 500 will be described. The agent device 500 interacts with, for example, the occupant of the vehicle M (for example, the user U2 or the like), transmits speech data from the occupant acquired by the microphone 610 to the information providing device 100 in the online state, and presents a response obtained from the information providing device 100 to an occupant in the form of sound output or image display. The agent device 500 includes, for example, a manager 520, an agent function element 540, and a vehicle-side storage 560. The manager 520 includes, for example, a sound processor 522, a display controller 524, and an audio controller 526. A software arrangement shown in FIG. 11 is simply shown for the sake of description. Actually, for example, the software arrangement may be arbitrarily modified so that the manager 520 is interposed between the agent function element 540 and the in-vehicle communication device 670.

Each component other than the vehicle-side storage 560 of the agent device 500 is implemented by, for example, a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (the non-transitory storage medium) such as a DVD or a CD-ROM and installed when the storage medium is mounted in a drive device.

The vehicle-side storage 560 may be implemented by the above-mentioned various types of storage devices, EEPROM, ROM, RAM, or the like. The vehicle-side storage 560 stores, for example, offline data 562, programs, and various other types of information. The offline data 562 is provided from the information providing device 100.

The manager 520 functions by executing a program such as an operating system (OS) or middleware. The sound processor 522 performs sound processing on an input sound so that a state suitable for recognizing information about an inquiry, a request, or the like among various types of speech received from the occupant (for example, the user U2) of the vehicle M is provided.

The display controller 524 generates an image of the response information corresponding to the inquiry information from the occupant of the vehicle M for the output device such as the display/operation device 620 in accordance with an instruction from the agent function element 540. The image of the response information is, for example, an image showing a list of shops or facilities showing a response result for the inquiry, the request, or the like, an image related to each shop or facility, an image showing a traveling route to a destination, an image showing other recommendation information or the start or end of processing, or the like.

The audio controller 526 causes some or all of speakers included in the speakers 630 to output speech in accordance with an instruction from the agent function element 540. The speech includes, for example, speech for an agent image to interact with the occupant, speech corresponding to the image output to the display/operation device 620 by the display controller 524, and speech based on the response result.

The agent function element 540 provides a service including a speech response in accordance with an utterance of the occupant of the vehicle M on the basis of various types of information acquired by the manager 520. The agent function element 540 may be implemented using, for example, a natural language processing function, an interaction management function of interacting with the user U2, and a network search function of searching for another device via a network or searching a prescribed database owned by its own device, and the like in an integrated manner in addition to a speech recognition function of recognizing the speech of the user U2. Some or all of these functions may be implemented by AI technology. Some of the components for performing these functions may be mounted in the information providing device 100.

For example, the agent function element 540 transmits a speech stream processed by the sound processor 522, information acquired from the navigation device 640, the occupant recognition device 690, the vehicle device 660, and the like, a control state of the automated driving control device 700, and the like to the information providing device 100 via the in-vehicle communication device 670 and provides the information obtained from the information providing device 100 to the occupant. The agent function element 540 may have a function of cooperating with the general-purpose communication device 680 and communicating with the information providing device 100. In this case, the agent function element 540 performs pairing with the general-purpose communication device 680 using, for example, Bluetooth (registered trademark) and connects the agent function element 540 and the general-purpose communication device 680. The agent function element 540 may be connected to the general-purpose communication device 680 through wired communication using a universal serial bus (USB) or the like.

When offline data has been acquired from the information providing device 100 at a prescribed interval or a prescribed timing, the agent function element 540 causes the vehicle-side storage 560 to store the acquired offline data as the offline data 562. The agent function element 540 acquires a communication state associated with the information providing device 100 in the in-vehicle communication device 670 or the general-purpose communication device 680, acquires response information corresponding to inquiry information with reference to the offline data 562 on the basis of the inquiry information included in speech when the communication state is an offline state or when the user U2 has received an instruction to use the offline data 562, and provides the acquired response information to the occupant via the manager 520. Thereby, even if the vehicle M (the agent device 500) and the information providing device 100 are in the offline state, the offline data 562 can be used to provide information to the occupant. By using the offline data 394 according to the instruction of the user U1 not only in the offline state but also in the online state, an amount of communication data can be reduced.

### Generation and Provision of Offline Data

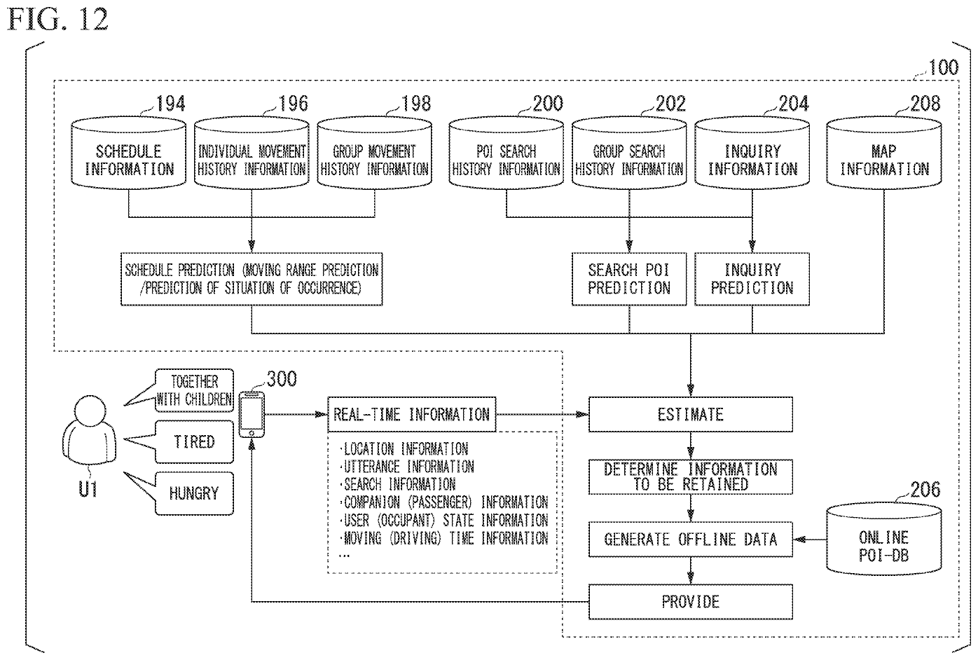

Next, the generation and provision of offline data according to the embodiment will be described with reference to the drawings. FIG. 12 is a diagram for describing a flow until offline data is generated and provided. The example of FIG. 12 shows the case where offline data is generated and provided in an online state. In the example of FIG. 12, it is assumed that the communication terminal 300 is used as an example of a mobile communication device. In the example of FIG. 12, it is assumed that the individual movement history information 196, the group movement history information 198, the POI search history information 200, and the group search history information 202 are already stored in the storage 190. In the following description, here, in the information shown in FIGS. 3 to 8, information displayed at the beginning (front) of each drawing is assumed to be information of the user U1.

In the example of FIG. 12, the predictor 140 of the information providing device 100 predicts a schedule of the user U1 on the basis of at least one of the schedule information 194, the individual movement history information 196, and the group movement history information 198. A schedule prediction process may include a process of predicting a future moving range or predicting a situation of occurrence of an offline state. For example, the predictor 140 predicts that a moving range of the user U1 is near station A to which he or she will move on foot or that there is a high possibility that the user U1 will go to a massage shop near station A every Friday night on the basis of information of a “destination” of the schedule information 194 shown in FIG. 3, a “destination” or a “transportation means” of the individual movement history information 196 shown in FIG. 4, or the like. On the basis of, for example, the group movement history information 198 shown in FIG. 5, the predictor 140 predicts that there is a high possibility that the group will go out during the consecutive holidays.

The predictor 140 predicts POI information searched for by the user U1 and inquiry information (for example, meta-information that is a key of the inquiry) on the basis of at least one of the POI search history information 200, the group search history information 202, and the inquiry information 204. For example, the predictor 140 predicts that the user U1 will be likely to ask about a location of a restaurant or a gas station on the weekend on the basis of the POI search history information 200 shown in FIG. 6. The predictor 140 predicts that the user U1 will be likely to ask about a location or reputation of a shop serving food and drink such as a pub or a restaurant and about whether or not it is a good place to go with children when the user U1 is acting in a group on the basis of the group search history information 202 shown in FIG. 7. The predictor 140 predicts that a “meal” is the most common genre (meta-information) about which the user U1 asks on the basis of the POI search history information 200, the group search history information 202, and the inquiry information 204 shown in FIG. 8.

Next, the estimator 150 of the information providing device 100 estimates a situation in which the state will be the offline state in the future on the basis of the real-time information acquired from the communication terminal 300 of the user U1 and the prediction result of the predictor 140 described above. The real-time information includes, for example, the location information of the communication terminal 300 and the utterance information and the search information of the user U1 with respect to the communication terminal 300. The utterance information includes semantic information. In the example of FIG. 12, it is assumed that the utterance information having the meanings of “together with children,” “tired,” and “hungry” is included in the real-time information due to the utterance of the user U1. The real-time information may include information of a companion who accompanies the user U1 and acts together with the user U1, user state information, and moving time information. When the user is in the vehicle M, the real-time information includes passenger information, occupant state information, driving time information, and the like.

The estimator 150 estimates a future situation of the user on the basis of the schedule information 194 and the schedule prediction result. In the example of FIG. 12, the offline situation is further estimated on the basis of the real-time information. In the example of FIG. 12, because the estimator 150 predicts that the user will eat at a restaurant or the like, it is estimated that there is a high possibility that the user asks about information of the restaurant present within a prescribed distance from the current location. The estimator 150 estimates a situation in which the state will be the offline state in the future on the basis of the schedule information 194, the schedule prediction result, the movement history (individual movement history information or group movement history information), and the like. Situations in which the state will be the offline state include, for example, the case where the user U1 moves by subway due to the schedule of the user U1 and therefore moves to the underground where the communication environment is poor, the case where a vehicle into which the user U1 gets moves to a place where a communication environment is poor such as a tunnel, the case where the user U1 moves to a region where a communication environment is not well developed in a trip or the like, and the like. The estimator 150 may estimate a start time point and an end time point of a situation in which the state will be the offline state.

The estimator 150 may estimate POI information (for example, POI category information, individual POI information, or inquiry meta-data) about which the user U1 is likely to ask in the offline state and the like on the basis of the POI search history information 200, the group search history information 202, and the inquiry information 204. The POI category information is, for example, information about a genre such as a “meal” or “clothing.”

The retention information determiner 160 determines the information to be included in the offline data to be retained in the communication terminal 300 on the basis of an estimation result of the estimator 150. For example, the retention information determiner 160 determines to include information of POIs near an arrival station for which an inquiry or a request from the user U1 is estimated for 30 minutes after 5 minutes from now when the state will be the offline state in the offline data if it is estimated that the state will be the offline state for the 30 minutes because the user U1 uses the subway on the basis of the estimation result of the estimator 150. In this case, the retention information determiner 160 determines to include POI information related to the meal near the arrival station and POI information of a massage shop and the like in the offline data on the basis of orientation information and an action history of the user U1 and the like.

The retention information determiner 160 determines information to be included in the offline data on the basis of the orientation information and the action history of the user U1 even if the estimator 150 estimates that the offline state will not occur in the future. Thereby, the POI information and the like can be provided using the offline data even in the offline state under a sudden situation or a situation that does not correspond to a past history.

The offline data generator 170 acquires information determined to be retained in the communication terminal 300 by the retention information determiner 160 with reference to the online POI-DB 206 and generates offline data having a smaller amount of information than the online POI-DB 206. The provider 180 transmits the generated offline data to the communication terminal 300.

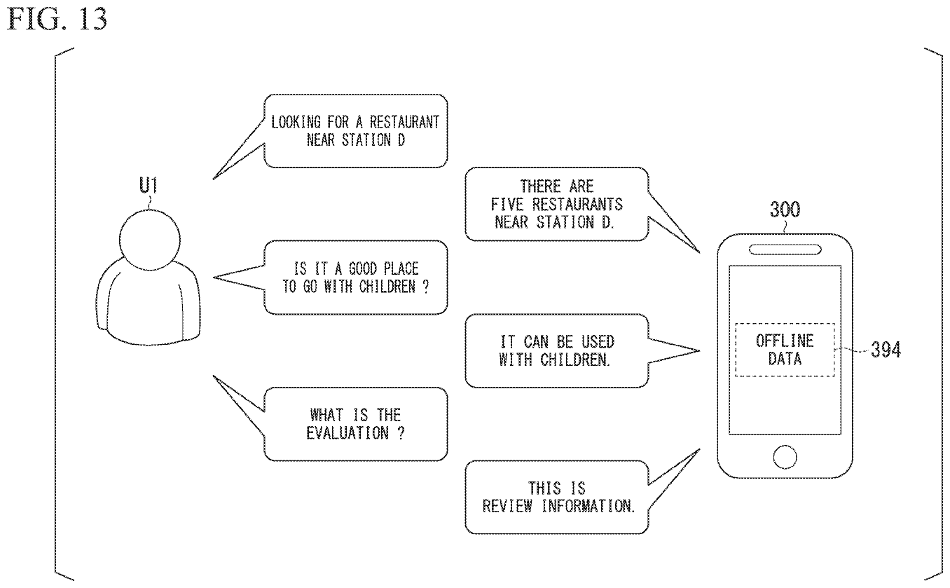

FIG. 13 is a diagram showing an example in which information is provided in the offline state. In the example of FIG. 13, an example of an interaction between the user U1 in company with a child heading to station D on the subway and the communication terminal 300 retaining offline data 394 is shown. In the example of FIG. 13, it is assumed that the communication terminal 300 is in the offline state in association with the information providing device 100. In the example of FIG. 13, it is assumed that the user U1 makes an utterance such as “Looking for a restaurant near station D” toward the communication terminal 300 in the offline state. The communication terminal 300 acquires utterance information of the user U1, extracts semantic information such as a “search for restaurants near station D” from the acquired utterance information, searches for restaurants within a prescribed distance from station D from the offline data 394 on the basis of the extracted semantic information, and outputs speech such as “There are five restaurants near station D.” as response information. In this case, information of the five restaurants may be displayed in a list on the display 330 of the communication terminal 300.

Next, it is assumed that that user U1 selects one of the five restaurants and makes an utterance such as “Is it a good place to go with children?” with respect to the selected restaurant. The communication terminal 300 acquires utterance information and outputs a message such as “It can be used with children.” with reference to the offline data 394 on the basis of the acquired utterance information. Further, it is assumed that the user U1 makes an utterance “What is the evaluation?”. The communication terminal 300 acquires the utterance information, acquires review information for the restaurant selected by the user U1 included in the offline data 394, outputs a message such as “This is review information.”, and outputs the review information to the display. When the user U1 has made the utterance “What is the route?”, the communication terminal 300 may cause a route to the restaurant selected by the user U1 to be displayed. When the user U1 has made the utterance “What is the menu?”, the communication terminal 300 may cause a menu of the restaurant selected by the user U1 to be displayed on the display 330. In this way, more appropriate information can be provided even in the offline state.

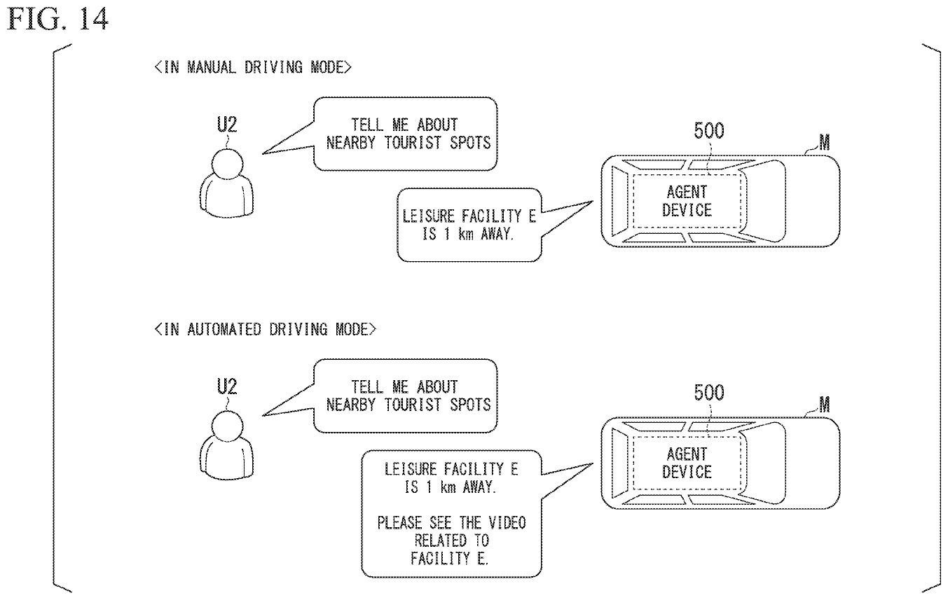

Although the example using the communication terminal 300 has been described above, the agent device 500 mounted in the vehicle M can also store the offline data as described above, so that more appropriate information can be provided to the occupants even if the agent device 500 is in the offline state. FIG. 14 is a diagram for describing information provided to the user U2 in the manual driving and the automated driving. In the example of FIG. 14, a state of an interaction between the user U2 and the agent device 500 when the vehicle M is in the manual driving mode and the automated driving mode is shown.

In the example of FIG. 14, a response result when the agent device 500 has acquired the utterance “Tell me about nearby tourist spots.” from the user U2 in both the manual driving mode and the automated driving mode is shown. In the manual driving mode, the user U2 needs to monitor the surroundings of the vehicle M. Therefore, the agent device 500 causes speech data such as “Leisure facility E is 1 km away.” to be output from the speaker 630 without displaying content such as a video. On the other hand, in the automated driving mode, in addition to a process of causing the speaker 630 to output the speech data “Leisure facility E is 1 km away.” as the response result, speech data such as “Please see the video related to facility E.” is output from the speaker 630, and the video related to facility E is output to the display/operation device 620. In this way, when information is provided from the agent device 500 mounted in the vehicle M to the user U2, the provision situation is different on the basis of the situation of the vehicle M, so that more appropriate information can be provided in accordance with a vehicle situation.

### Processing Flow

Next, a flow of a process executed by the information providing system according to the embodiment will be described. Hereinafter, a process executed by the information providing device 100 and a process executed by the communication terminal 300, which is an example of the mobile communication device, will be described separately. In the following process, an example in which offline data is mainly generated and provided to the communication terminal 300 within the process executed by the information providing device 100 will be mainly described. In the process of the communication terminal 300, the process of providing information to the user U1 mainly through the interaction with the user U1 will be mainly described. In the information providing device 100, it is assumed that information such as the schedule information 194, the individual movement history information 196, the group movement history information 198, the POI search history information 200, the group search history information 202, and the inquiry information 204 related to the user U1 are already accumulated and user authentication is also completed.

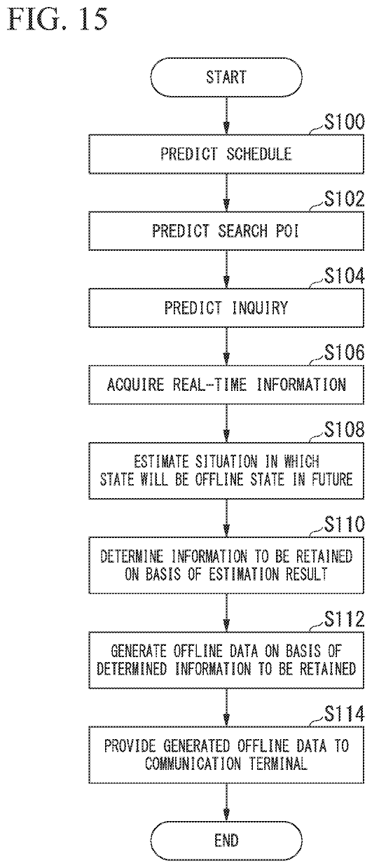

FIG. 15 is a flowchart showing an example of a flow of a process executed by the information providing device 100. In the example of FIG. 15, the predictor 140 predicts a schedule of the user U1 on the basis of the schedule information 194, the individual movement history information 196, and the group movement history information 198 (step S100). Subsequently, the predictor 140 predicts POI information that the user U1 is likely to search for in the future on the basis of the POI search history information 200, the group search history information 202, and the inquiry information 204 (step S102) and predicts inquiry content (step S104). The processing of steps S100 to S104 may be executed at a prescribed interval or at a prescribed timing before the processing from step S106 is executed.

Subsequently, the acquirer 130 acquires real-time information from the communication terminal 300 (step S106). Subsequently, the estimator 150 estimates a situation in which the communication terminal 300 will be in the offline state in the future on the basis of the acquired real-time information, the schedule prediction result, and the map information 208 (step S108). Subsequently, the retention information determiner 160 determines the information to be retained in the communication terminal 300 as offline data on the basis of an estimation result of the estimator 150 (step S110).

Subsequently, the offline data generator 170 acquires information from the online POI-DB 206 on the basis of the information determined by the retention information determiner 160 and generates the offline data (step S112). The offline data may include map information acquired from the map information 208. Subsequently, the provider 180 provides the generated offline data to the communication terminal 300 (step S114). Thereby, the process of the present flowchart ends.

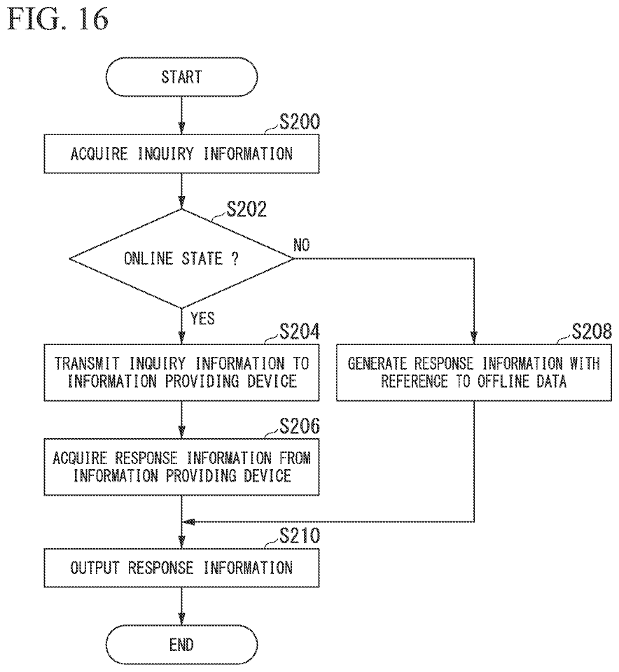

FIG. 16 is a flowchart showing an example of a process executed by the communication terminal 300. In the process of FIG. 16, it is assumed that the offline data provided in the process of FIG. 15 is stored in the terminal-side storage 390 of the communication terminal 300. In the example of FIG. 16, it is assumed that the information providing application 392 is activated in the communication terminal 300. In the example of FIG. 16, the information providing application 392 acquires inquiry information from the user U1 (step S200). Subsequently, the information providing application 392 determines whether or not the communication terminal 300 and the information providing device 100 are in the online state (step S202). When it is determined that the communication terminal 300 and the information providing device 100 are in the online state, the information providing application 392 transmits the inquiry information to the information providing device 100 (step S204) and acquires response information for the inquiry information from the information providing device 100 (step S206). When it is determined that the communication terminal 300 and the information providing device 100 are not in the online state (or is in the offline state) in the processing of step S202, the information providing application 392 generates response information for the inquiry information with reference to the offline data (step S208). After the processing of step S206 and step S208, the response information is output (step S210). Thereby, the process of the present flowchart ends.

In the process shown in the above-described flowchart, when the mobile communication device is the agent device 500 (the vehicle M), the number of types of information or an amount of information may be greater when the vehicle M is traveling in the automated driving mode than when the vehicle M is traveling in the manual driving mode in the processing of step S100.

### Modified Example

In the above-described embodiment, when the user U1 who uses the communication terminal 300 drives the vehicle M, the information providing device 100 may provide information to one or both of the communication terminal 300 and the agent device 500. In this case, the information may be provided to one selected by the user U1 and the information may be provided using one piece of the offline data stored in each of the communication terminal 300 and the agent device 500 in which the latest offline data is accumulated. The information providing device 100 may provide information to the agent device 500 when the vehicle M is traveling and may provide information to the communication terminal 300 when the vehicle M is stopped.

The information providing device 100 may store information (an offline history) related to a place or a time period where or when the state was the offline state in the past in the storage 190 and predict a situation in which the mobile communication device will be in the offline state in the future on the basis of the offline history and the real-time information.

According to the embodiment described above, the information providing device 100 includes the provider 180 configured to provide a mobile communication device (the communication terminal 300 or the agent device 500) of a user with information to be output to the mobile communication device in an online state on the basis of information acquired from the mobile communication device; the schedule acquirer 132 configured to acquire a schedule of the user; the schedule predictor 142 configured to predict a schedule of the user; the estimator 150 configured to estimate a situation in which the mobile communication device of the user will be in an offline state in the future on the basis of the schedule acquired by the schedule acquirer 132 and the schedule predicted by the schedule predictor 142; and the retention information determiner 160 configured to determine information to be retained in the mobile communication device on the basis of an estimation result of the estimator 150, so that it is possible to provide more appropriate information to the user even if the mobile communication device is in the offline state.

Specifically, according to the above-described embodiment, a situation in which an offline state occurs in a daily moving range, a time period of a meal such as lunch, and the like is predicted from an action schedule and a prediction result for a user and POI information to be retained as offline data is determined from the predicted situation, search results, action histories, and orientation information for an individual and a group, and the like. Thereby, it is possible to search for and provide POI information in an environment where it is difficult to ensure the communication state. Therefore, according to the above-described embodiment, it is possible to appropriately support the user not only in the online state but also in the offline state.

The embodiment described above can be represented as follows.

An information providing device including:

a storage device storing a program; and

a hardware processor,

wherein the hardware processor executes the program stored in the storage device to:

provide a mobile communication device of a user with information to be output from the mobile communication device in an online state on the basis of information acquired from the mobile communication device;

acquire a schedule of the user;

predict a schedule of the user;

estimate a situation in which the mobile communication device of the user will be in an offline state in the future on the basis of the acquired schedule and the predicted schedule; and

determine information to be retained in the mobile communication device on the basis of an estimation result.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information providing device comprising:
a provider configured to provide a mobile communication device of a user with information to be output from the mobile communication device in an online state on the basis of information acquired from the mobile communication device;
a schedule acquirer configured to acquire a schedule of the user;
a schedule predictor configured to predict a schedule of the user;
an estimator configured to estimate a situation in which the mobile communication device of the user will be in an offline state in the future on the basis of the schedule acquired by the schedule acquirer and the schedule predicted by the schedule predictor; and
a retention information determiner configured to determine information to be retained in the mobile communication device on the basis of an estimation result of the estimator.

2. The information providing device according to claim 1, wherein the retention information determiner determines information to be retained in the mobile communication device on the basis of orientation information indicating orientation of the user and utterance information between the user and the mobile communication device.

3. The information providing device according to claim 1, wherein the mobile communication device includes a device mounted in a vehicle.

4. The information providing device according to claim 3,
wherein the vehicle is an automated driving vehicle, and
wherein the retention information determiner causes one or both of the number of types of information and an amount of information to be retained in the mobile communication device to be greater when the automated driving vehicle is traveling in an automated driving mode than when the automated driving vehicle is not traveling in the automated driving mode.

5. The information providing device according to claim 1, wherein the schedule predictor performs a prediction process related to location information or time information for the user to eat, move, or rest.

6. The information providing device according to claim 1,
wherein the information to be output from the mobile communication device is information to be output from the mobile communication device in the offline state, and
wherein the information to be output from the mobile communication device includes audio information for interacting with the user.

7. The information providing device according to claim 1, wherein the retention information determiner adjusts information to be provided in accordance with an empty space of a storage provided in the mobile communication device and to be retained in the mobile communication device.

8. An information providing method comprising:
providing, by a computer, a mobile communication device of a user with information to be output from the mobile communication device in an online state on the basis of information acquired from the mobile communication device;
acquiring, by the computer, a schedule of the user;
predicting, by the computer, a schedule of the user;
estimating, by the computer, a situation in which the mobile communication device of the user will be in an offline state in the future on the basis of the acquired schedule and the predicted schedule; and
determining, by the computer, information to be retained in the mobile communication device on the basis of an estimation result.

9. A computer-readable non-transitory storage medium storing a program for causing a computer to:
provide a mobile communication device of a user with information to be output from the mobile communication device in an online state on the basis of information acquired from the mobile communication device;
acquire a schedule of the user;
predict a schedule of the user;
estimate a situation in which the mobile communication device of the user will be in an offline state in the future on the basis of the acquired schedule and the predicted schedule; and
determine information to be retained in the mobile communication device on the basis of an estimation result.
